(19) United States
(12) Patent Application Publication
(10) Pub. No.: US 2009/0287659 A1
(43) Pub. Date: Nov. 19, 2009

(54) NETWORK BROWSER SUPPORTING HISTORICAL HYPERTEXT AND OTHER LINKS

(76) Inventor: James D. Bennett, Hroznetin (CZ)

Correspondence Address: GARLICK HARRISON & MARKISON, P.O. BOX 160727, AUSTIN, TX, 78716-0727, US

(21) Appl. No.: 12/422,499

(22) Filed: Apr. 13, 2009

Related U.S. Application Data
(60) Provisional application No. 61/053,269, filed on May 15, 2008.

(51) Int. Cl. G06F 17/30

(52) U.S. Cl. 707/3; 707/E17.108

(57) ABSTRACT

An Internet infrastructure supports searching of web links wherein if a user desires to obtain historical Internet data that existed as of a past date or time or if current web content cannot be provided to the user due to web changes, maintenance, technical reasons, etc., then a server provides historical data to the user. The user selects a hyperlink, web page, search string, address, or other method for obtaining web content. The servers provide current web content if it is available and provide options to obtain historical content for the user to access if stored and/or if the current content is not active or available at the moment and historical info is available. The user is provided with options, such as ‘original’, ‘timeline view’ or ‘specify timeframe’ that allow a search server and a historical data repository to pull past or historical Internet media, data, text, documents, web pages, etc., for presentation to the user. Therefore, if a user desires historical content or an error message prevents delivery of current content, the user can still access historical content over the Internet.

### CROSS REFERENCES TO RELATED APPLICATIONS

The present application claims priority under 35 U.S.C. 119(e) to U.S. Provisional Application Ser. No. 61/053,269, filed May 15, 2008, and having a common title with the present application, which is incorporated herein by reference in its entirety for all purposes.

### SPECIFICATION

### BACKGROUND

1. Technical Field

The present invention relates generally to Internet infrastructures; and, more particularly, to search engines.

2. Related Art

Network browsers display web contents for users to view and browse. Often, the page content is provided from a distantly located host server. Commercially available network browsers present HTML web page contents. These contents are displayed on a computer screen and the content contains written texts, images, media, graphics, advertisements, etc. The texts and images typically contain links that allow user to jump to another web page or document via hyperlinks. The network browsers also contain address bar(s) that allows the user to provide an address or URL of a particular web page belonging to a web site. The network browser directs the address to a host server and retrieves a HTML file containing the contents and displays the contents on the computer screen.

If a requested website has been shut down, if web pages are kept in a different file in the host server, if the website has been shifted to another domain, or if the host server is overloaded (among other conventional reasons), the network browsers display/return an HTTP 404 error to the user requesting the information. The HTTP 404 error indicates to the user that the requested file is not available for some reason, but the exact reason may not be known or discernable.

For example, when a user attempts to download a document, say http://www.xyz.com/doc1.html, a network browser may display a HTTP 404 error. The user may not know the reason why the error occurred. It could be because of a failed Internet connection. But then, when the user attempts another web address (say, http://www.abc.com/index.htm) the network browser displays that web page correctly. The user may try again with the http://www.xyz.com/doc1.html and again experience the same problem by getting the same error message. The user may determine that the http://www.xyz.com/doc1.html is a dead link, that the server down, or that the server is too busy. Often, the user may attempt to try again later. In another example, the user intending to view a web page or document (say, http://www.xyz.com/doc1.html) that he/she visited sometime ago, may find that web page or document http://www.xyz.com/doc1.html has changed from that content that was present during the previous visit (and the visit may be from a favorite list selection by the user, and result in the same HTTP 404 error).

These and other limitations and deficiencies associated with the related art may be more fully appreciated by those skilled in the art after comparing such related art with various aspects of the present invention as set forth herein with reference to the figures.

### BRIEF SUMMARY OF THE INVENTION

The present invention is directed to apparatus and methods of operation that are further described in the following Brief Description of the Drawings, the Detailed Description of the Invention, and the claims. Other features and advantages of the present invention will become apparent from the following detailed description of the invention made with reference to the accompanying drawings.

### BRIEF DESCRIPTION OF THE DRAWINGS

FIG. 1 is a schematic block/step diagram illustrating an Internet infrastructure containing a client device with a network browser, wherein the network browser is incorporated with a historical timeline support module that assists in retrieving as-of-this-date web pages or documents from historical repositories;

FIG. 2 is a schematic block/step diagram illustrating components of the search engine server and historical data support repository first presented in FIG. 1;

FIG. 3 is an exemplary diagram illustrating a snap shot of a search interface web page used by the search engine server of FIG. 1, wherein the web page is displayed in the network browser and wherein the network browser address bar provides options to retrieve as-of-this-dated web pages or documents from the search engine server;

FIG. 4 is an exemplary diagram illustrating a snap shot of a search engine server's search result page wherein the network browser provides options to retrieve original or current web pages or documents via ‘timeline view’ and ‘specify timeframe’ options;

FIG. 5 is an exemplary diagram illustrating a snap shot of a search engine server's search result page wherein the network browser provides options to choose dates in ‘specify timeframe’ option;

FIG. 6 is an exemplary diagram illustrating a snap shot of a web page or document page wherein the network browser provides options, to retrieve original or current web pages or documents by providing ‘timeline view’ and ‘specify timeframe’ options;

FIG. 7 is an exemplary diagram illustrating a snap shot of a search result page wherein the search engine server provides options to retrieve original or current web pages or documents using ‘timeline view’ and ‘specify timeframe’ options along with web links;

FIG. 8 is an exemplary diagram illustrating a snap shot of a “page not found error” wherein the network browser provides options to retrieve original content or options to provide a ‘timeline view’ and ‘specify timeframe’ options;

FIG. 9 is a flow diagram illustrating the functionality of the historical timeline support module of FIG. 1; and

FIG. 10 is a flow diagram illustrating the functionality of the search engine server of FIG. 1.

### DETAILED DESCRIPTION OF THE DRAWINGS

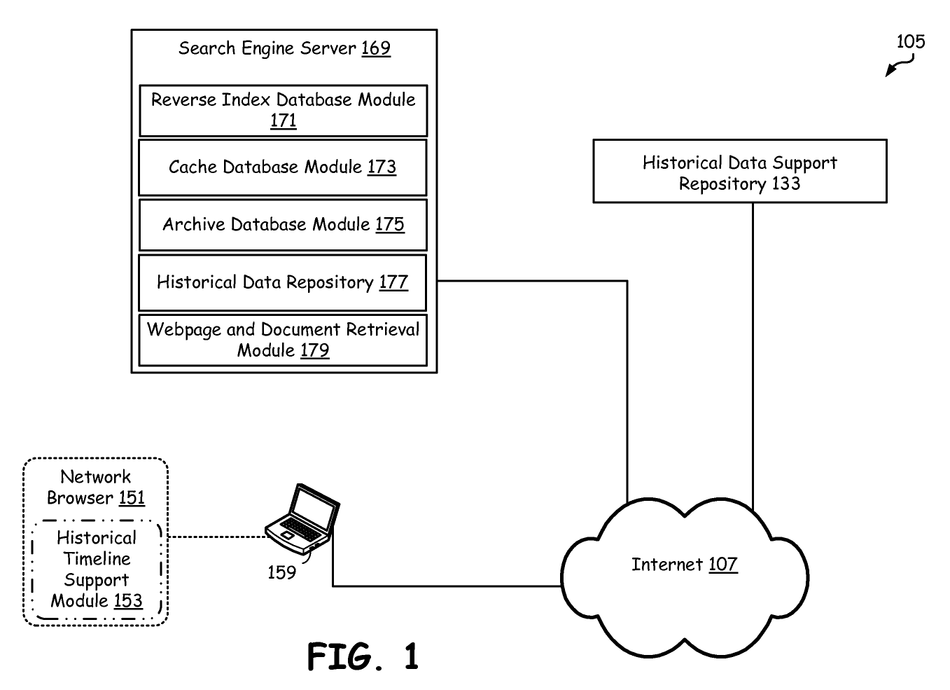

FIG. 1 is a schematic block/step diagram illustrating an Internet infrastructure 105. Infrastructure 105 contains one or more client devices 159 containing a network browser 151. Infrastructure 105 also contains a network browser accessible search engine server 169 and historical data support repository 133, wherein the network browser is associated with or contains a historical timeline support module 153 that assists in retrieving as-of-this-date web pages or documents as of a certain date or a past version. In specific, the network browser (or web browser) 151, instead of delivering a page not found error (hyper text transfer protocol 404 error—http 404 error) either offers user an option of going back in time and obtaining a last original version or obtaining an as-of-this-date version of the web page or document. In addition, the browser 151 may allow the user to automatically obtain an older version of the web page or document, even if the original content or more recent content is available. The page not found error can occur because of shutting down of web site, shifting of web site to another domain, overloading of host server etc. When this happens, content is often totally unavailable to the user using conventional browsers. However, these errors can be addressed with historical content pages and the need to find older content may be addressed in general by the network browser 151 in conjunction with the search engine server 169 and historical data support repository 133.

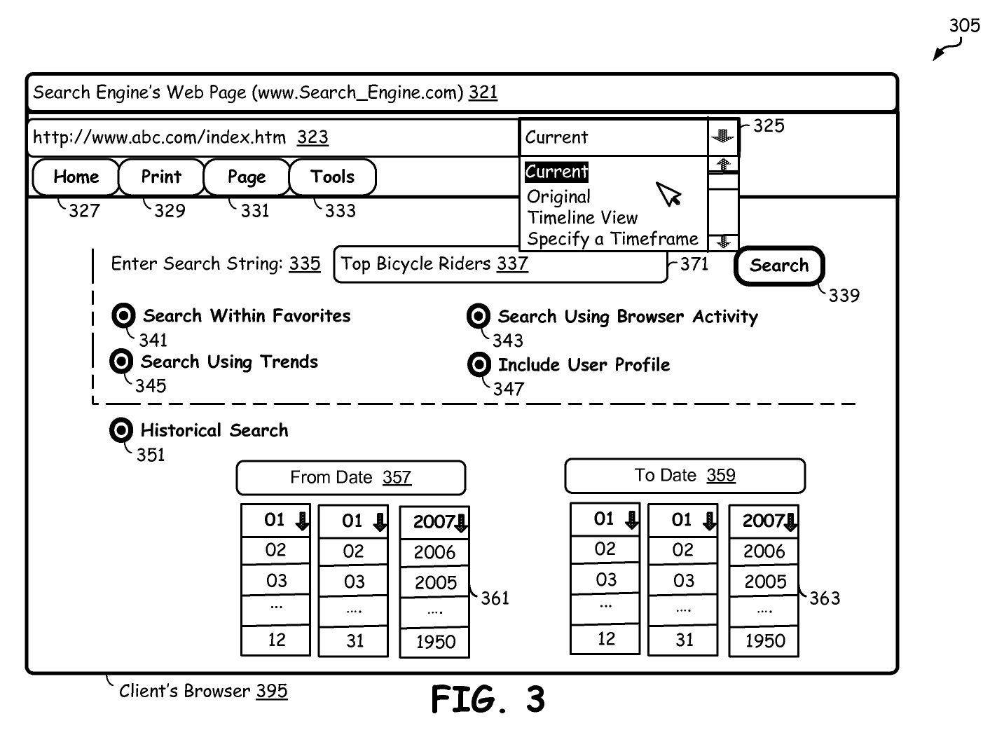

The network browser 151 and/or the historical timeline support module 153 in FIG. 1 employs one of many ways of implementing the delivery of as-of-this-date web pages and documents from the entry of addresses in the address bar as well as from the web links, hyperlinks, and other links contained within the documents, media, and web pages being browsed by the user. The address bar allows a user to enter address of the web pages or documents and to choose among many possible options to be able to access current content/information or as-of-this-date web pages or documents (refer to the snapshot FIG. 3 for detailed description of how to select these options). The possibilities for selection include: (a) current; (b) original; (c) timeline view; or (d) specify a timeframe. Lesser number of selections, combinations of these selections, or more selections/modes than this are also possible. The ‘current’ web page or document is a default option, and is often configured to be used when no selection is made. However, a control panel option or browser option can be provided to allow the user to change default modes if they wish to do so. In FIG. 1, when the user enters an address and presses an ‘enter’ key, the network browser 151 directs the address to a host server or DNS server (not shown in FIG. 1) and through a complex process potentially involving many servers, will attempt to obtain the current web page or document. Alternatively, a user may choose from the options ‘current’ and obtain the current web page or document directly from the host server.

When the user chooses the ‘original’ option, the historical timeline support module 153 identifies the Internet Protocol Address (IP Address) of the search engine server 169 and redirects the address to the search engine server 169 rather than an existing server on which the content is currently stored. In some embodiments, the existing server that contains current content and the server that contains original content or historical content (like server 169) are one and the same or two or more servers linked in the same data room. In response, the search engine server 169 delivers an original web page or document that is associated with the host server's current web page or document. The original web page or document, for example, may be the first version of the current web page or document that was obtained during crawling of the Internet (or a similar network or networks) for the first time.

The ‘timeline view’ option allows the user to download a list of web links, each one directing the user/browser to a specific version of the web page or document. Often, these web pages or documents are different documents or versions as stored over time in a historical/archive/cache database in server 169 or related storage. These web links are delivered in the search result list format, by the search engine server 169. In this case, the historical timeline support module 153 identifies the Internet Protocol Address (IP Address) of the search engine server 169 and redirects the address to the search engine server 169, for delivery of timeline view as requested by the browser or the user.

The option ‘specify a timeframe’ allows the user to specify a timeframe within which the various archived/historical versions of the web page or document are to be delivered. The search engine server 169 delivers various web links related to the web page or document as they existed within or over the specified timeframe. For example, if the user chooses two dates such as Mar. 21, 1999 and Apr. 21, 1999, the search engine server delivers all of the available versions or time-based archived copies of the web pages or documents within these dates. There may be zero to any number of archived copies within this date range for a given web site or address. Again, the historical timeline support module 153 redirects the address to the search engine server 169, for delivery of web links within the timeframe.

The search engine server 169 or a separate or server-integrated historical data support repository 133 stores many versions of a web page or document for delivery upon certain historical requests (as mentioned in the above paragraphs). These historical versions are obtained during periodic, constant, or other systematic and routine Internet crawling processes/operations performed by the search engine server 169 and/or historical data support repository 133. Along with the stored historical versions, other metadata information related to the web page and document may be stored in the search engine server 169 or historical data support repository 133. And, as noted before, the server 169 and repository 133 may be separate servers, the same server, two separate servers connected by a specific fast connect other than the Internet, or some other configuration of hardware, either integrated or separated.

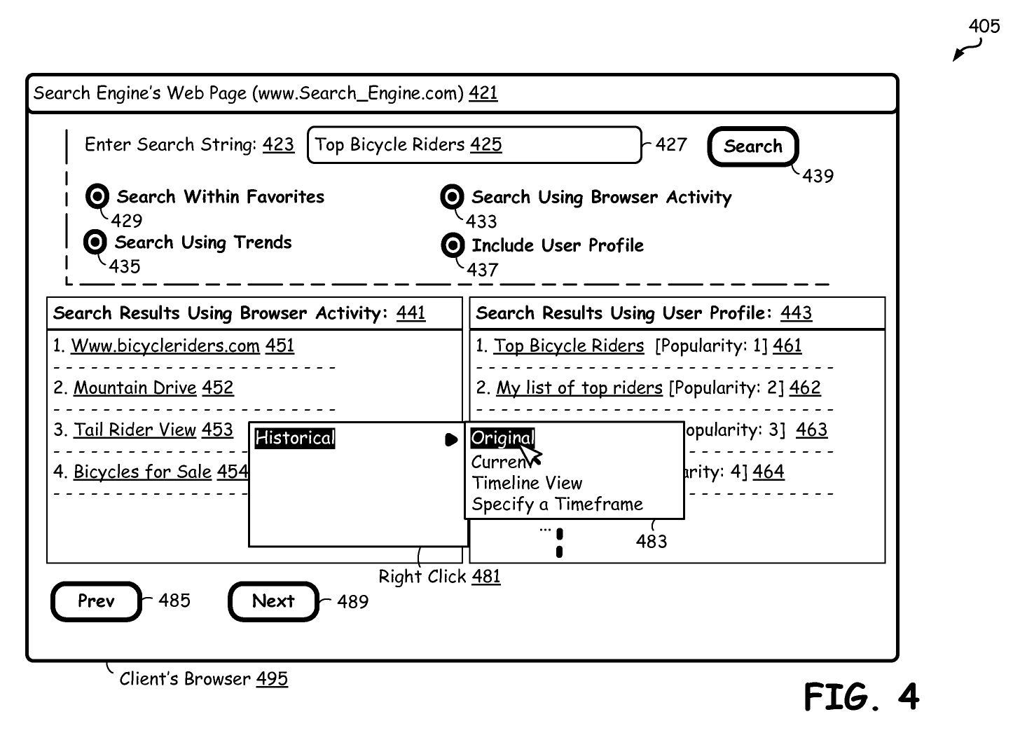

In addition, the historical timeline support module 153 provides mouse click options (e.g., right click options) to the web links in a search result list (during delivery of search results) or links in a web page or document. When the user right clicks on these web links, the network browser 151 provides options of ‘current’, ‘original’, ‘timeline view’, or ‘specify a timeframe’ among others. These options lead, as mentioned in the above paragraphs, to a current web page or document from a current host server, or an as-of-this-date web page or documents (original, or within a specified timeframe, or via another algorithm) from the search engine server 169 and/or historical data support repository 133. FIGS. 4, 5, and 6 are useful figures for understanding of the details of right clicks options in conjunction with the web links of search result list, web pages, or documents.

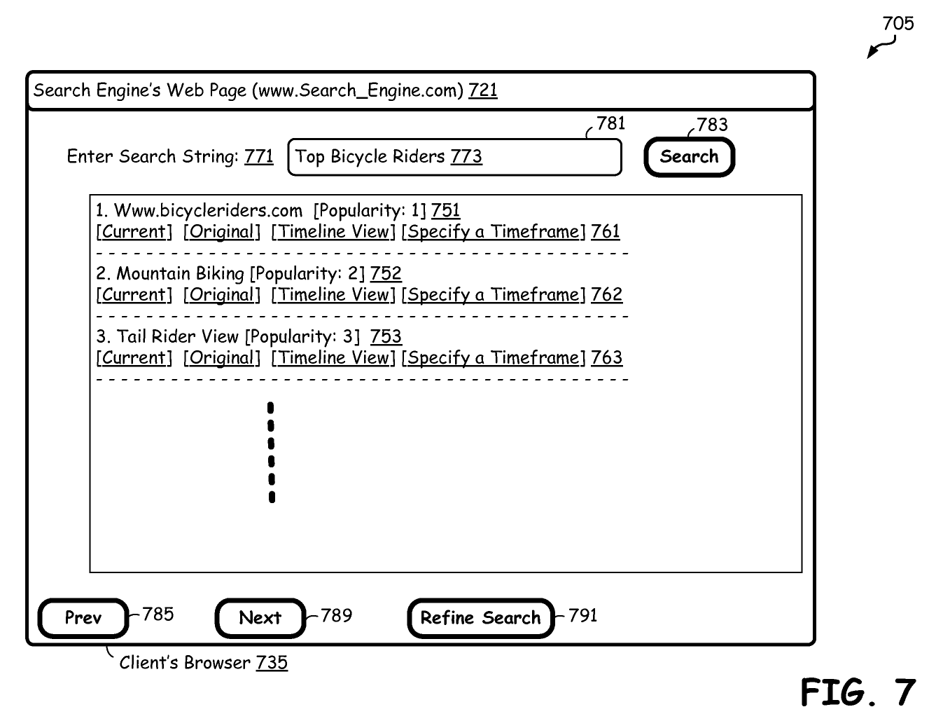

In another embodiment, the search engine server 169 delivers search result pages with various options to deliver as-of-this-date web pages, without the help of the network browser. This process may work well with legacy network browsers. For example, the search result list can be returned containing search result web links and also provide options just below the web link that include ‘current’, ‘original’, ‘timeline view’ or ‘specify a timeframe’. Using these options, the user may obtain a current version of the web page or document from a host server or as-of-this-date versions from the search engine server 169 (refer to the description of snapshot FIG. 7).

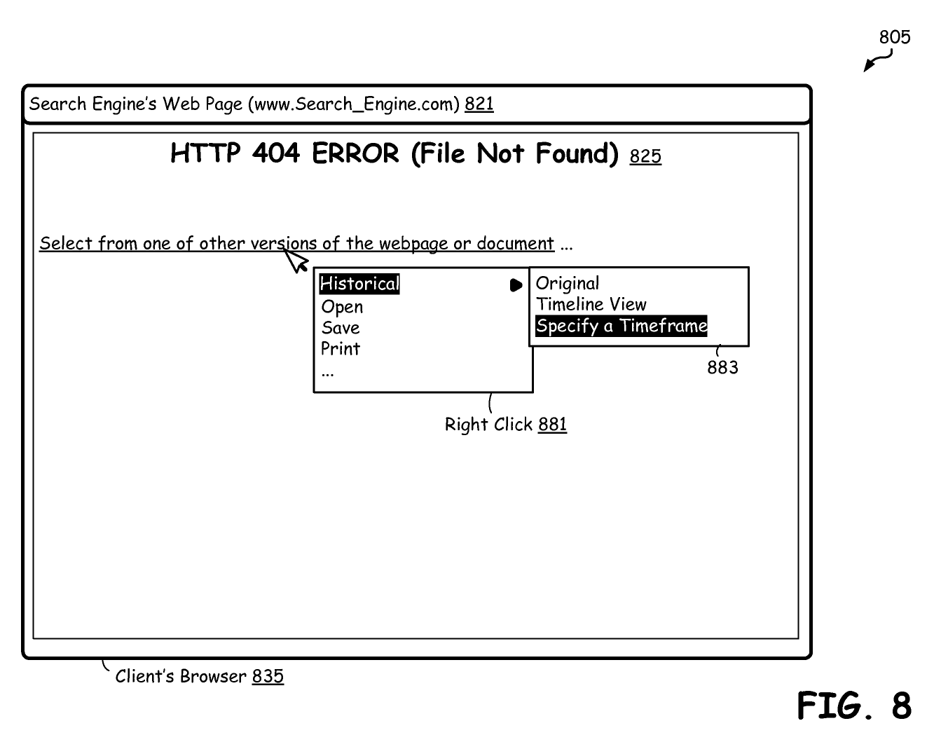

In addition, if a page not found error 9 e.g., HTTP 404 error) occurs during any of the above mentioned operations, then the historical timeline support module 153 either provides options ‘current’, ‘original’, ‘timeline view’ or ‘specify a timeframe’ to obtain an as-of-this-date web page or document, or the module 153 automatically delivers one of the as-of-this-date versions of the web page or document with a helpful note mentioning the version and date of the web page or document and/or a helpful indication that this document is archived and not current. In other words, the network browser 151, in most of the cases, may not deliver the page not found error at all, and may instead assist in delivering an as-of-this-date version automatically from the search engine server 169 to “cover” the error and provide some content to the user that may be meaningful other than an error message. Or, the browser 151 may provide an option to the user to retrieve one or more prior versions of the web page or document (for this option, please refer to the description of the snapshot in FIG. 8).

The Internet infrastructure 105 illustrated in FIG. 1 contains the search engine server 169 and historical data support repository 133 communicatively coupled to the client device 159 via an Internet 107 or some other optical, wireless, and/or wireline network. The search engine server 169 contains reverse index database module 171, cache database module 173, and archive database module 175 to assist in storing and delivering search result pages. A historical data repository 177 contained in the search engine server 169 (along with the external historical data support repository 133) store various versions of the web pages and documents from a plurality of host servers during routine historic crawling over time. In one embodiment, the repository 177 is a smaller cache space that can be utilized to store some highly trafficked data from repository 133. A web page and document retrieval module 179 retrieves and processes (as needed) as-of-this-date web page or document upon request from the network browser 151 or another request source.

Conventionally, a network browser displays an HTTP 404 error if a requested web site has been shut down, the web pages are now kept in a different file in the host server, the web site has been shifted to another domain, and the host server is overloaded, among other reasons. The network browser 151 of FIG. 1, in accordance with one embodiment, does not display HTTP 404 error, but instead delivers an alternative web page or document that is an older version of the current web page or document.

For example, when a user attempts to download a document, say http://www.xyz.com/doc1.html, a network browser may display a HTTP 404 error. The user may not know the reason why the error occurred. It could be because of Internet connection. But then, when the user attempts another web address (say, http://www.abc.com/index.htm) the network browser displays that other web page correctly. The user may try again with the http://www.xyz.com/doc1.html and again the same 404 error problem. The user may determine that the http://www.xyz.com/doc1.html is a dead link or server is down or too busy. Often, the user will attempt to try again later, sometimes the user will give up seeking the information they desired. In either event, the user may simply have wanted information that old/historic/archived page would have satisfied. In another example, the user may find a web page or document with the http://www.xyz.com/doc1.html, but it may have been changed from that during a previous visit (may be from a favorite list), and the user may desire the previous version or certain information that was contained in the previous version but is not present on the current version of the web page.

With reference to the above example, the network browser 151 of the current embodiment detects that historical data is requested and automatically redirects the web address http://www.xyz.com/doc1.html to the search engine server 169, such as http://www.serachengineserver.com/xyz/doc1.html. Then, the web page and document retrieval module 179 of the search engine server 169 responds by searching for one of most recent or recently archived versions (after which the link http://www.xyz.com/doc1.html became dead) of the web page or document doc1.html. The web page and document retrieval module 179 may search either in the historical data repository 177 within or associated with the server 169 or historical data support repository 133 for the most recent or applicable version of the web page or document for doc1.html, such as doc1_version_15.html. The server 169 or repository 133 then delivers the doc1_version_15.html to the network browser 151 for presentation to the user. The network browser 151 in turn displays the web page or document doc1_version_15.html to the user instead of displaying HTTP 404 error or instead of continuing to display the current version of the page when the user wants a past version. Alternatively, the network browser 151 (depending on the settings within or associated with the network browser 151) may provide options of ‘current’, ‘original’, ‘timeline view’ or ‘specify a timeframe’, so that the user may choose which version of the document should be displayed when an error message or newer version is presented. In other embodiments, the system can present the most recent/newest/current web page and allow the user to select to move back in time to prior versions if they wish to do so through user selections or a graphical user interface.

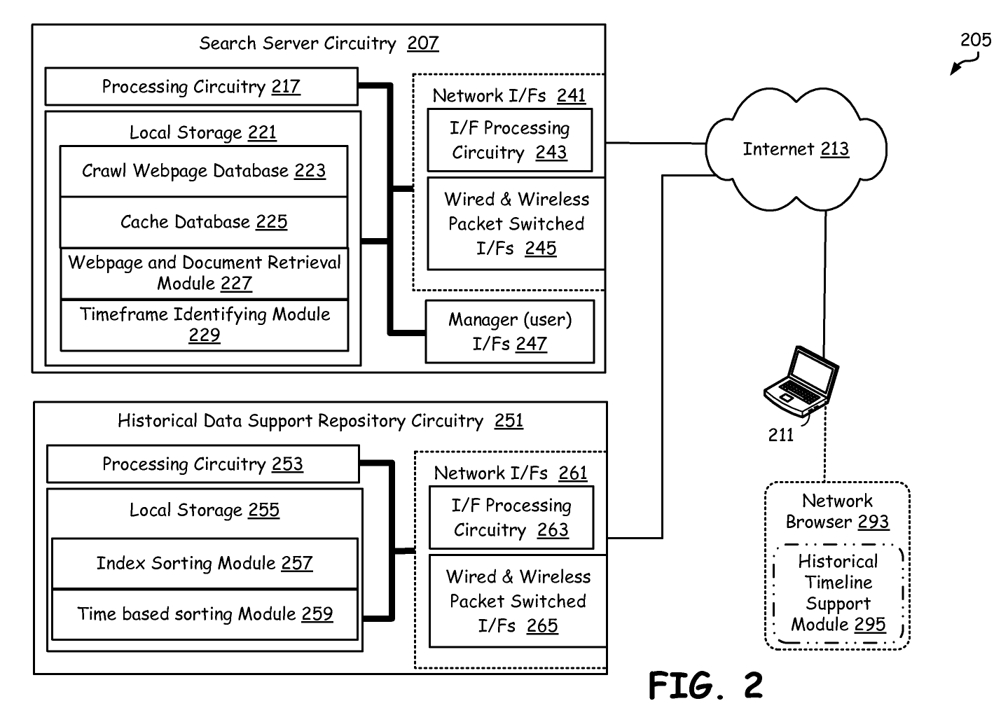

FIG. 2 is a schematic block/step diagram illustrating the components of the search engine server 207 and historical data support repository 251 constructed in accordance with the embodiments discussed per FIG. 1. The search engine server 207 or historical data support repository 251 may in part or full be incorporated into any computing device that is capable of serving as one or more Internet based server. Further, circuitry 207 resides within the server 169 of FIG. 1, and repository 251 of FIG. 2 is analogous to repository 133 of FIG. 1.

The search engine server circuitry 207 generally includes processing circuitry/CPU 217, local storage 221, manager/management interfaces 247, and network interfaces 241. These components are communicatively communicating with one another via one or more of a system bus, dedicated communication pathways, control signals, address/data busses, package switches, serial interfaces, or other direct or indirect communication pathways. The processing circuitry 217 may be, in various embodiments, a microprocessor, a central processing unit (CPU), a graphics processing unit (GPU), a digital signal processor (DSP), a microcontroller unit, a state machine, an application specific integrated circuit (ASIC), a field programming gate array (FPGA), multi-core engines, any combinations of the foregoing, or other processing circuitry.

Local storage 221 may be any random access memory, read-only memory, electrically erasable memory, nonvolatile memory, flash memory, a disk drive, an optical drive, combinations thereof, or another type of memory that is operable to store computer instructions and data. The local storage 221 includes a crawl web page database 223, cache database 225, web page and document retrieval module 227 and timeframe identifying module 229 to facilitate a user's search and delivery of historical web pages and documents, in accordance with the embodiments taught herein. The client device 211 illustrated in FIG. 2 communicates with the search engine server 207 via an Internet 213 or another network, and contains a network browser 293 and historical timeline support module 295 as previously discussed for client 159 of FIG. 1.

Similarly, the historical data support repository 251 generally includes processing circuitry/CPU 253, local storage 255, and network interfaces 261 for communicating with other networks, the Internet, or other computing/storage/peripheral devices. These components communicate with one another via one or more of a system bus, address/data paths, control signals, dedicated communication pathways, combinations thereof, or other direct or indirect communication pathways. The processing circuitry 253 may be, in various embodiments, a microprocessor, a digital signal processor, a state machine, an application specific integrated circuit, a field programming gate array, or other processing circuitry as discussed for processing circuitry 217. Generally, I/O functions in modern servers and computers have their own dedicated processing circuitry so I/O operations do not burden the performance of main CPUs, like processing circuitry 217.

Local storage 255 may be any one or more of any random access memory, read-only memory, electrically erasable memory, non-volatile memory, flash memory, a disk drive, an optical drive, combinations thereof, or any other type of memory or system that is operable to store computer instructions and data. The local storage 255 includes an index-sorting module 257 and time-based sorting module 259 that facilitate historical data support repository functionality, in accordance with the embodiments taught herein. The client device 211 illustrated in FIG. 2 is communicatively coupled to the historical data support repository 251 via the Internet 213 or other network(s).

The web page and document retrieval module 227 retrieves data from historical data repository (177 of FIG. 1) or from historical data support repository 251, upon request from the network browser 293. The timeframe-identifying module 229 identifies and retrieves various versions of a web page or document from the historical data repository 177 of FIG. 1 or historical data support repository 251 as shown in FIG. 2. In some cases, data may be cached or stored within local storage within the server 169 of FIG. 1 or the circuitry 207 of FIG. 2.

The network interfaces 241 contain wired and/or wireless packet switched interfaces 245 and may also contain built-in or an independent interface processing circuitry/CPU 243. The network interfaces 241 allow the search engine server 207 to communicate with many different client devices such as devices 211 and to deliver as-of-this-date web pages or documents. Client devices may be more than personal computers or laptops, devices 211 can be any device that has Internet or network capability, like global positioning systems, satellites, cell phones, routers, appliances, automobile controllers, servers, supercomputers, etc. The manager interfaces 247 may include a display and keypad interfaces as well. These manager interfaces 247 allow the user or an IT professional at the search engine server 207 to control aspects of the system. Similarly, the network interfaces 261 contain wired and/or wireless packet switched interfaces 265, and may also contain built-in or an independent interface processing circuitry/CPU 263. The network interfaces 261 allow the historical data support repository 251 to communicate with one or more client devices such as device 211 and search server circuitry 207, and interfaces 261 allow the system to deliver as-of-this-date web pages or documents to users.

In other embodiments, the search engine server 207 and the historical data support repository 251 of FIG. 2 may include fewer or more components than are illustrated as well as lesser or further functionality. In other words, the illustrated search engine server and historical data support repository are meant to merely offer examples of possible functionality and construction in accordance with one embodiment.

FIG. 3 is an exemplary diagram illustrating a snap shot of search interface web page 305 of the search engine server of FIG. 1 displayed in the network browser 395 (analogous to browsers 151 and 293 in FIGS. 1-2 respectively), wherein the network browser address bar provides options to retrieve as-of-this-date web pages or documents from the search engine server. Note, while the historical pages are referred to as “as-of-this-date” there are other ways to tag and store web pages and documents other than by date, they could be stored by version number, time, counters, etc. Returning to FIG. 3, the exemplary snap shot illustrated in FIG. 3 shows the search engine server's search interface web page 305 delivered to the client device's network browser 395 as used to facilitate a user's search. The search facilities illustrated allow the user to search within favorites 341, search using browser activity 343, search using trends 345, include user profile 347, and also allow the user to search historically 351 using radio button selectors, user entered input, or other forms of user selection or interface to the browser. Historical search 351 uses a timeframe selected using dropdown menus 357, 361, 359 and 363 in FIG. 3, although other interfaces are possible.

The search engine server's search interface web page 305 may contain a page title such as ‘Search Engine's web page (www.Search_Engine.com)’ 321 in FIG. 3, and a ‘search’ 339 button. In addition, a text such as ‘Enter Search String:’ 335 and text box 371 are provided to facilitate the entry and modification of user search information. The user may enter the search string in the text box 371, such as ‘Top Bicycle Riders’ 337 in FIG. 3, make appropriate choices using radio buttons 341, 343, 345, 347 and 351 and click on the ‘search’ button 339 to initiate a new search.

In accordance with embodiments taught herein, the address bar also comes with a dropdown menu 325 that allows a user to go back in time while attempting to retrieve a file from a host server. For example, the user may enter http://www.abc.com/index.htm 323 and may select one or more option of ‘current’, ‘original’, ‘timeline view’, or ‘specify timeframe’ from the dropdown menu 325. Then, the network browser automatically redirects the file request to the search engine server for any option in the dropdown menu other than ‘current’, as the accessing of archived historical information may require a search of a new server or storage space or different search operations/methods. If the requested file is not found in any real-time or currently-operational associated database or storage area, the network browser provides or uses options of ‘current’, ‘original’, ‘timeline view’ or ‘specify a timeframe’ to obtain an as-of-this-date web page or document or automatically delivers one of as-of-this-date version of the web page or document to the user with a helpful note/notice mentioning the version and date of the web page or document. Also, once a web page or a list of search results are returned to the user, each web page or search result may be provided with a selection that allows the user to cycle the web page content or data, backward or forward in time or version to different historical instantiations of the data.

FIG. 4 is an exemplary diagram illustrating a snap shot of a search engine server's search result page 405 wherein the network browser 495 provides options to retrieve original or current web page or document, provide ‘timeline view’ and ‘specify timeframe’ options via right clicks on a link. The exemplary snap shot illustrated in FIG. 4 shows a search result page 405 as delivered to the network browser 495 of a client device to facilitate user's search. The search result page 405 illustrated contains a page title such as ‘Search Engine's web page (www.Search_Engine.com)’ 421, and a ‘search’ button 439. In addition, the search interface web page 405 also contains ‘search within favorites’ 429, ‘search using browser activity’ 433, ‘search using trends’ 435 and ‘include user profile’ 437 radio buttons that help refine a new search, if initiated by the user. A text such as ‘Enter Search String:’ 423 and text box 427 are provided to facilitate the user's search. The user may enter a search string in the text box 427, such as ‘Top Bicycle Riders’ 425, make appropriate choices per the interface of FIG. 4, and click on ‘search’ 439 to initiate a new search. The first search result page 405 also contains the ‘prev’ 485 and ‘next’ buttons 489 to access prior displayed search result pages and the subsequent search result pages, respectively.

In addition, the first search result page 405 illustrated in the exemplary snap shot shows two columns, namely, ‘Search Results Using Browser Activity’ 441 and ‘Search Results Using User Profile’ 443. The two columns illustrated show web links 451 through 454 and 461 through 464, under the columns ‘Search Results Using Browser Activity’ 441 and ‘Search Results Using User Profile’ 443, respectively. It is important to note that the search results can be presented in other forms or in other assorted lists, especially if different selections are made via the search interface of FIG. 4.

In accordance with FIG. 4, upon right clicking 481 on any of the displayed links, the network browser 495 provides a historical search option 483. Under this historical option, the network browser 495 provides a menu 483 containing various search historical, date, version, or time-based options such as ‘original’, ‘current’, ‘timeline view’, and ‘specify a timeframe’.

The ‘current’ option is a default option, but may also be provided in the menu. When the user selects the ‘current’ option, the network browser 495 directs the address to a host server that contains the most recent and currently-operational web page, document, media, or content, and obtains and provides that current web page document, media, or content. When the user selects the ‘original’ option, the network browser 495 identifies the Internet Protocol Address (IP Address) of the search engine server 169 of FIG. 1 and redirects the address to the search engine server 169 or the corresponding repository 133. The search engine server 169 and/or repository 133 responds by delivering a stored/cached original web page or document that is associated with the host server's current web page or document. The original web page or document may be the first version that was cached the current web page or document and was obtained during crawling various locations for the first time. The ‘timeline view’ option of FIG. 4 allows the user to download a list of web links, each one directing the user to a specific version of the current web page or document, archived by some time indicator, such as version, date, time, sequential counter, etc. The network browser 495 redirects the requested address to the search engine server for delivery of timeline view/selection to the user. The option ‘specify a timeframe’ allows the user to specify a timeframe within which various versions of the web page or documents are to be delivered to the user. When using this option, the search engine server delivers one or more web links related to the web page or document within the specified timeframe, if any are archived.

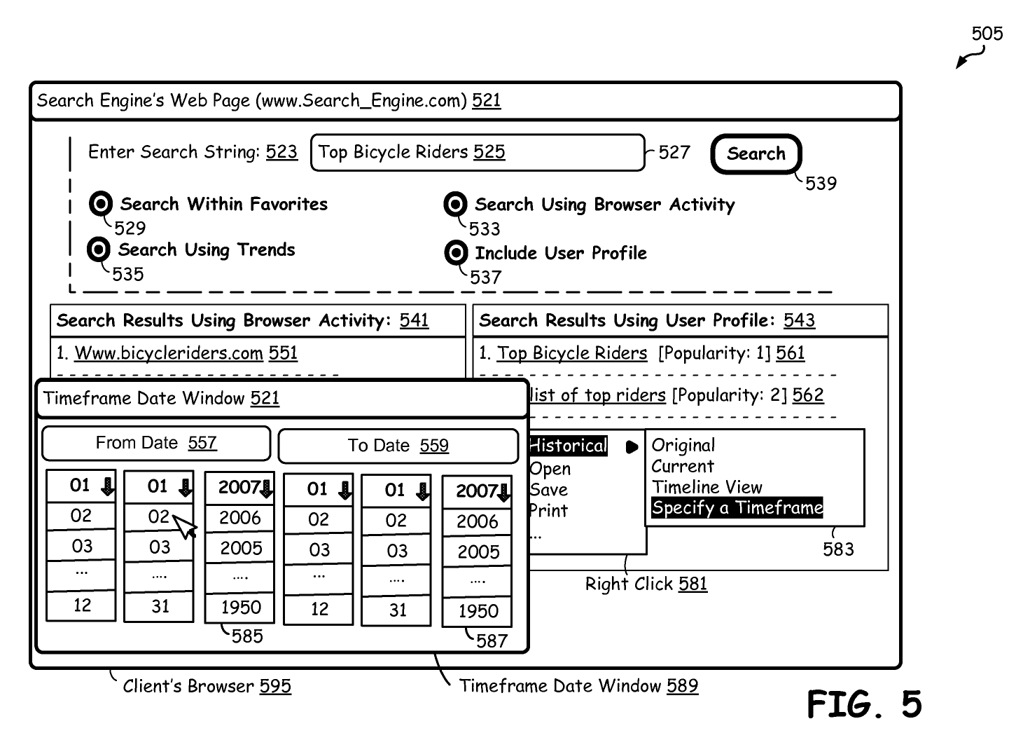

FIG. 5 is an exemplary diagram illustrating a snap shot of a search engine server's search result page wherein the network browser 595 provides options to choose dates or a date range/window for the ‘specify timeframe’ option. The exemplary snap shot illustrated in FIG. 5 has a search result page 505 delivered to the network browser 595 (similar to browser 151 of FIG. 1) of the client device to facilitate user searching. in FIG. 5, the user can right click on a right click historical menu 583 along with a timeframe date window 589, which is also illustrated. The search result page 505 illustrated in FIG. 5 contains a page title such as ‘Search Engine's web page (www.Search_Engine.com)’ 521, and a ‘search’ 539 button. In addition, the search interface web page 505 also contains ‘search within favorites’ 529, ‘search using browser activity’ 533, ‘search using trends’ 535 and ‘include user profile’ 537 shown in FIG. 5 as radio buttons that help refine a new search, if initiated by the user. A text such as ‘Enter Search String:’ 523 and text box 527 are provided to facilitate user search input. The user may enter one or more search strings in the text box 527, such as ‘Top Bicycle Riders’ 525, make appropriate choices in FIG. 5 and click on the ‘search’ button 539 to initiate a new search. The first search result page 505 also contains the ‘prev’ and ‘next’ buttons (not visible in FIG. 5) to access prior displayed search result pages and the subsequent search result pages, respectively. In addition, the first search result page 505 illustrated in the exemplary snap shot shows two columns, namely, ‘Search Results Using Browser Activity’ 541 and ‘Search Results Using User Profile’ 543. The two columns illustrated show some of the links visible as 551, 561, and 562, under the search-related columns ‘Search Results Using Browser Activity’ 541 and ‘Search Results Using User Profile’ 543.

In accordance with the embodiments taught herein, upon right clicking 581 on any of the displayed link, the network browser 595 provides a historical search option. Under this historical option, the network browser provides a menu 583 containing various search options such as ‘original’, ‘current’, ‘timeline view’, and ‘specify a timeframe’. The option ‘specify a timeframe’ allows the user to specify a timeframe within which the versions of the web page or document are to be delivered. Upon clicking on the ‘specify a timeframe’ option, a timeframe date window 589 opens up. The timeframe date window may have a title 521. The timeframe date window 589 provides a drop down menu 557/85 to fill in the ‘from date’ and a drop down menu construct 559/587 to fill in the ‘to date’. The network browser 595 sends this date information along with the web address to the search engine server 169 and/or repository 133 of FIG. 1. The search engine server 169 or repository 133 delivers web links related to the web page or document within the specified timeframe. The data desired by the browser may be stored in the repository 133 and not in the server 169, or may be in the server 169 but not yet permanently archived in the repository 133, or may be redundantly stored/cached in both where one is a more current and workable version that the other. In these cases, it may be beneficial to provide the address and date information to both repository 133 and server 169 so parallel processing in both locations can provide the best data in the shortest period of time.

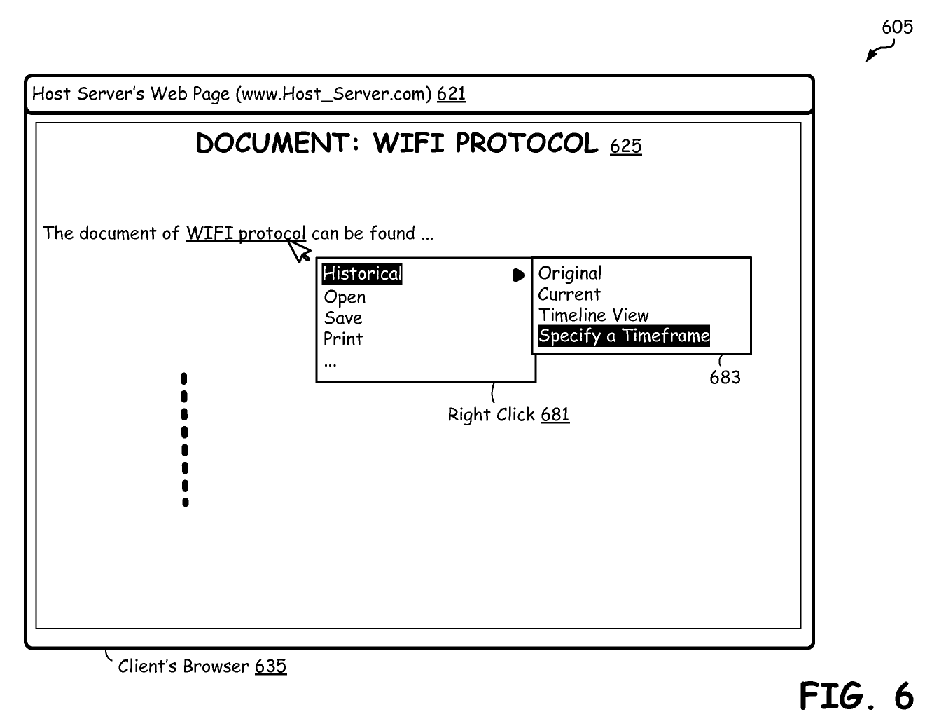

FIG. 6 is an exemplary diagram illustrating a snap shot of a web page or document page 605 wherein the network browser provides options, to retrieve an original or current web page or document via ‘timeline view’ and ‘specify timeframe’ options that can be selected upon right clicking on a link. Specifically, the exemplary snap shot illustrated in FIG. 6 shows a web page or document page 605 as delivered to the client device's web browser 635 in response to a request by the user that is entered via address bar, web links elsewhere within the browser, or via search results. The web page or document page 605 may contain a page title such as ‘Host Server's web page (www.Host_Server.com)’ 621, and additional web page or document contents with web links that connect to other web pages or documents.

Upon right clicking 681 on any of the displayed web links, the network browser 635 provides a historical search option window. When this historical option is selected, the network browser 635 provides a menu 683 containing various search options such as ‘original’, ‘current’, ‘timeline view’, and ‘specify a timeframe’. The ‘current’ option is a default option, but may also be provided in the menu. When the user selects ‘current’ option, the network browser 635 directs the address to a host server and obtains the current Internet-active web page or document. If the user selects the ‘original’ option, the network browser 635 redirects the address to the search engine server. The search engine server responds by delivering an original web page or document (which may be the first version of the current web page or document that was obtained during crawling for the first time) that is associated with the host server's current web page or document. The ‘timeline view’ option allows the user to download a list of web links, each one being linked or addressed to a specific version of the web page or document in a historical archive. The network browser 635 redirects the address to the search engine server, for delivery of a timeline view. The option ‘specify a timeframe’ allows the user to specify a timeframe within which the versions of the web page or document are to be delivered. The search engine server delivers web links related to the web page or document within the specified timeframe. Upon clicking on the ‘specify a timeframe’ option, a timeframe date window opens up (as illustrated in FIG. 5). The timeframe date window provides facilities to fill in ‘from date’ and ‘to date’. The network browser 635 sends this information along with the web address to the search engine server 169 and/or repository 133 and receives web links related to the web page or document within the specified timeframe.

FIG. 7 is an exemplary diagram illustrating a snap shot of a search result page 705. In FIG. 7, the search engine server provides options to retrieve original or current web pages or documents, provide ‘timeline view’ and ‘specify timeframe’ options, along with web links. In this embodiment, the exemplary snap shot illustrated shows the search result page 705 as delivered to the client device's web browser 735. The search result page 705 may contain a page title such as ‘Search Engine's web page (www.Search_Engine.com)’ 721. In addition a text such as ‘Enter Search String:’ 771 and text box 781 are provided to facilitate user's search. The user may enter the search string in the text box 781, such as ‘Top Bicycle Riders’ 773, make appropriate choices using radio buttons and click on ‘search’ button 783 to initiate a new search.

The search result page also contains a search result list illustrated as search results 751 through 753. In accordance with the present invention, the search engine server delivers not only web links 751 through 753 but also options such as ‘original’, ‘current’, ‘timeline view’ and ‘specify a timeframe’, 761 through 763. In some embodiments, the protocol will be to only present the options that actually can lead to further valid data. Therefore, if a stored page only has a current version and an original version, then there may not be an option presented for ‘timeline view’ or ‘specify a timeframe’, etc. The ‘current’ option is also a default option, but may also be provided in the menu. When the user selects a web link or ‘current’ option, the network browser 735 directs the address to a host server and obtains the current web page or document. For example, when the user clicks on the web link 751, the search engine server addresses the web link to a host server. In the ‘original’ option, the search engine server addresses web link to the search engine server. The original web page or document may be the first version of the current web page or document that was obtained during crawling for the first time. In the ‘timeline view’ option, the search engine server allows the user to download a list of web links, each one directing to a specific version of the web page or document. The search engine server, in this case, redirects the address to the search engine server and/or historical repository, for delivery of the timeline view. In the option ‘specify a timeframe’, the search engine server and/or repository allow the user to specify a timeframe within which the versions of the web page or document are to be delivered.

FIG. 8 is an exemplary diagram illustrating a snap shot of a page not found error, wherein the network browser provides options, to retrieve original, provide options of ‘timeline view’ and ‘specify timeframe’ options. Specifically, the exemplary snap shot illustrated in FIG. 8 shows a page not found error (typically, HTTP 404 error) 825 delivered to the client device's web browser 835 in response to a request by the user via an address bar, web links elsewhere, or via search results. The network browser may or may not show any page not found error if set to do so, instead the browser may display a latest version of the web page or document found via historical processing taught herein.

In this embodiment, the illustration shows an embodiment where the HTTP 404 error page 805 shows there is an error when the network browser 835 settings allow display of this error. In addition, the HTTP 404 error page 805 may contain a page title such as ‘Search Engine's web page (www.Search_Engine.com)’ 821, and additional web page contents that are relevant to the error.

In accordance with the error recovery embodiments taught herein, the HTTP 404 error page 805 contains a web link with text such as ‘Select from one of other versions of the web page or document . . . ’ among other texts. Upon right clicking 881 on this web link, the network browser 835 provides a historical search options that may not be current but may assist the user in finding the information they desire. When this historical option is selected, the network browser 835 provides a menu 883 containing various search options such as ‘original’, ‘timeline view’, and ‘specify a timeframe’ (current is not provided since the error assumes that the current version is not currently available over the Internet). The ‘original’ option is a default option, but may also be provided in the menu. When the user selects ‘original’ option, the network browser 835 redirects the address to the search engine server. The search engine server responds by delivering an original web page or document (which may be the first version of the current web page or document that was obtained during crawling for the first time) that is associated with the host server's current web page or document. The ‘timeline view’ option allows the user to download a list of web links, each one directed to a specific version of the web page or document. The network browser 835 redirects the address to the search engine server and/historical repository in FIG. 1, for delivery of timeline view. The option ‘specify a timeframe’ allows the user to specify a timeframe within which the versions of the web page or document are to be delivered. The search engine server delivers web links related to the web page or document within the specified timeframe. Upon clicking on the ‘specify a timeframe’ option, a timeframe date window opens up (as illustrated per FIG. 5). The timeframe date window provides facilities to fill in ‘from date’ and ‘to date’. The network browser 835 sends this information along with the web address to the search engine server and receives web links related to the web page or document within the specified timeframe.

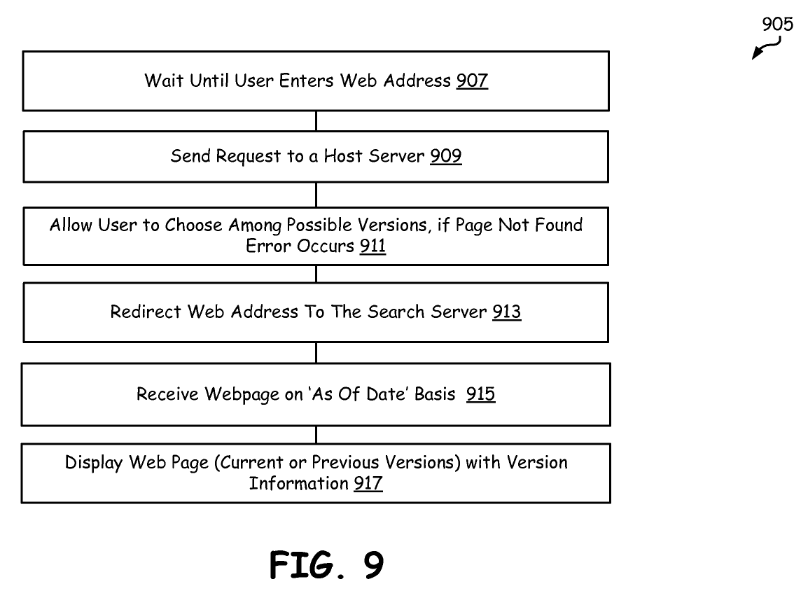

FIG. 9 is a flow diagram illustrating functionality of the historical timeline support module of FIG. 1. In this embodiment, the functionality begins at a block/step 907, where the historical timeline support module waits for a user of the client device to enter web address in address bar. At a next block/step 909, the historical timeline support module sends the web page or document request to the search engine server.

At a next block/step 911, the historical timeline support module allows the user to choose among possible versions, if page not found error occurs or if the user desires to obtain historical information. The historical timeline support module may allow the user to choose from possible versions either via displaying of a page not found error page (see FIG. 8) or using an option menu in the address bar. The various options for page processing include ‘original’, ‘current’, ‘timeline view’ and ‘specify a timeframe’, as taught herein. The historical timeline support module may also send the request to the host server or search engine server depending upon the option, among ‘current’, ‘original’, ‘timeline view’ and ‘specify a timeframe’, as selected.

The ‘current’ option is a default option. When the user selects the ‘current’ option, the historical timeline support module directs the address to a host server that can find and provide the current content on the Internet. If the user selects the ‘original’ option, the historical timeline support module redirects the address to the search engine server and/ore repository and retrieves an original web page or document that is associated with the host server's current web page or document. The ‘timeline view’ option allows the user to download a list of web links from the search engine server, each one directing to a specific version of the web page or document. The option ‘specify a timeframe’ allows the user to specify a timeframe within which the versions of the web page or document are to be delivered.

At a next block/step 913, the historical timeline support module redirects the web address to the search engine server, including user selection information (upon receiving HTTP 404 error). At a next block/step 915, the historical timeline support module receives web page on ‘as-of-this-date’ basis. At a next block/step 917, the historical timeline support module displays the web page (current or previous versions) with version information and proper user notices. The version/date/notice information allows the user to know that the web page is of an older version.

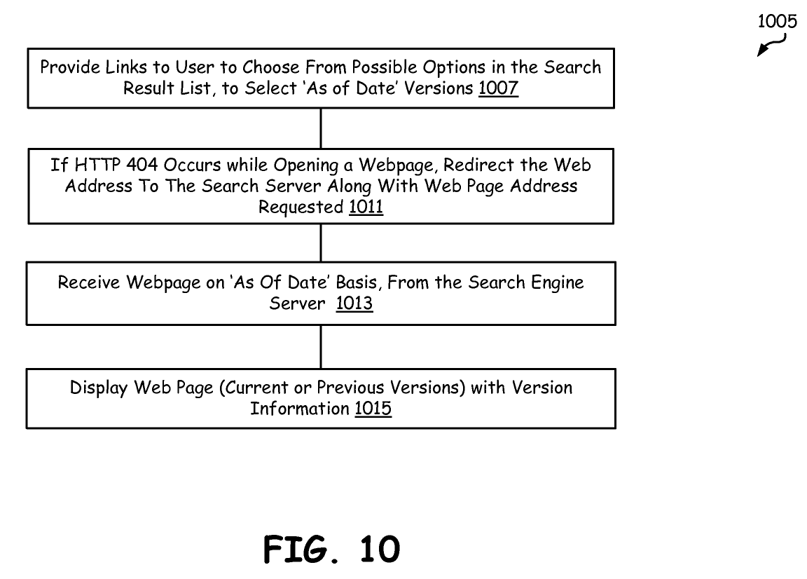

FIG. 10 is a flow diagram illustrating the functionality of the search engine server of FIG. 1, in accordance with the present invention. The functionality begins at a block/step 1007 where the search engine server 169 provides links to a user to choose from possible options in the search result list that allows the user to select ‘as-of-this-date’ versions. The possible options include ‘original’, ‘current’, ‘timeline view’, and ‘specify a timeframe’. The ‘current’ option is a default option. The web link or ‘current’ option contains address directed to a host server, to retrieve the current web page or document as currently operational on the Internet. For example, when the user clicks on the ‘current’ option, the search engine server addresses the web link to the host server and processes web page delivery in a normal mode. In the ‘original’ option, the search engine server addresses web link to the search engine server and/or repository. The original web page or document may be the first version of the current web page or document that was obtained during Internet archival crawling for the first time. In the ‘timeline view’ option, the search engine server allows the user to download a list of web links, each one directing to a specific version of the web page or document. The search engine server, in this case, redirects the address to the search engine server and/or repository, for delivery of the timeline view. In the option ‘specify a timeframe’, the search engine server allows the user to specify a timeframe within which the versions of the web page or document are to be delivered.

If HTTP 404 (page not found) error occurs while opening a user selected web page, the search engine server automatically redirects the address to the search engine server 169 along with required web page address information, at a next block/step 1011. At a next block/step 1013, the search engine server delivers an ‘as-of-this-date’ web page to the network browser. At a next block/step 1015, the network browser displays the web page that is current or an older version, with version information.

The terms “circuit” and “circuitry” as used herein may refer to an independent circuit or to a portion of a multifunctional circuit that performs multiple underlying functions. For example, depending on the embodiment, processing circuitry may be implemented as a single chip processor or as a plurality of processing chips. Likewise, a first circuit and a second circuit may be combined in one embodiment into a single circuit or, in another embodiment, operate independently perhaps in separate chips. The term “chip,” as used herein, refers to an integrated circuit. Circuits and circuitry may comprise general or specific purpose hardware, or may comprise such hardware and associated software such as firmware or object code.

As one of ordinary skill in the art will appreciate, the terms “operably coupled” and “communicatively coupled,” as may be used herein, include direct coupling and indirect coupling via another component, element, circuit, or module where, for indirect coupling, the intervening component, element, circuit, or module may or may not modify the information of a signal and may adjust its current level, voltage level, and/or power level. As one of ordinary skill in the art will also appreciate, inferred coupling (i.e., where one element is coupled to another element by inference) includes direct and indirect coupling between two elements in the same manner as “operably coupled” and “communicatively coupled.”

The present invention has also been described above with the aid of method steps illustrating the performance of specified functions and relationships thereof. The boundaries and sequence of these functional building blocks and method steps have been arbitrarily defined herein for convenience of description, and can be apportioned and ordered in different ways in other embodiments within the scope of the teachings herein. Alternate boundaries and sequences can be defined so long as certain specified functions and relationships are appropriately performed/present. Any such alternate boundaries or sequences are thus within the scope and spirit of the claimed invention.

The present invention has been described above with the aid of functional building block/steps illustrating the performance of certain significant functions. The boundaries of these functional building block/steps have been arbitrarily defined for convenience of description. Alternate boundaries could be defined as long as the certain significant functions are appropriately performed. Similarly, flow diagram block/steps may also have been arbitrarily defined herein to illustrate certain significant functionality. To the extent used, the flow diagram block/step boundaries and sequence could have been defined otherwise and still perform the certain significant functionality. Such alternate definitions of both functional building block/steps and flow diagram block/steps and sequences are thus within the scope and spirit of the claimed invention.

One of average skill in the art will also recognize that the functional building block/steps, and other illustrative block/steps, modules and components herein, can be implemented as illustrated or by discrete components, application specific integrated circuits, processors executing appropriate software and the like or any combination thereof. Although the Internet is taught herein, the Internet may be configured in one of many different manners, may contain many different types of equipment in different configurations, and may replaced or augmented with any network or communication protocol of any kind. Furthermore, client devices are often taught and depicted herein as laptop computers or personal computers (PCs), however, client devices can be cell phones, smart phones, palmtop computers, laptop computers, netbooks, mobile internet devices, point of sale devices, GPS systems, appliances, home security systems, DTVs, set top boxes, portable or fixed game consoles, workstations, supercomputers, other servers, personal device assistants (PDAs), or any other electronic device used by an end user.

Moreover, although described in detail for purposes of clarity and understanding by way of the aforementioned embodiments, the present invention is not limited to such embodiments. It will be obvious to one of average skill in the art that various changes and modifications may be practiced within the spirit and scope of the invention, as limited only by the scope of the appended claims.

1. A network browser adapted to operate with a client device, the network browser being adapted to access web pages and documents from Internet and from a search engine server, the network browser comprising:
a historical timeline support module wherein:
the network browser is adapted to receive a request from a user of the client device to retrieve a web page or a document from the Internet;
the network browser being adapted to send the request to a host server;
the network browser is adapted to receive information back from the host server and wherein the host server generates a page not found error;
the historical timeline support module is adapted to respond to the generation of page not found error by redirecting the request to the search engine server to attempt to obtain an as-of-this-date web page or document; and
the network browser is adapted to receive and display the as-of-this-date web page or document in response to the page not found error.

2. The network browser of claim 1, wherein the page not found error comprises a hypertext transfer protocol 404 error.

3. The network browser of claim 1, wherein the network browser automatically redirects the request to the search engine server, and displays the as-of-this-date web page or document without displaying the page not found error.

4. The network browser of claim 1, wherein the network browser provides options to the user before redirecting, the options allowing a user to obtain the as-of-this-date web page or document from the search engine server in a certain form.

5. The network browser of claim 4, wherein the options are selected from the following choices: download an original web page or document from the search engine server; download web links of prior versions of the web page or document, within a specified timeframe, that are obtained from the search engine server; and view a timeline that is obtained from the search engine server.

6. The network browser of claim 1, wherein the request is routed to both the search engine server and the host server and parallel processes wherein if the current version of the web page or a document is available the request to the host server is processed to the network browser and wherein if the current version of the web page or a document is not available, then a historic copy of a prior version of the web page or a document is provided to the network browser via the search engine server.

7. The network browser of claim 1, wherein the request is routed to both the search engine server and a historical data repository wherein if the current version of the web page or a document is not available from the host server then a historical copy of the web page or a document is provided from one of the search engine server or the historical data repository.

8. The network browser of claim 1, wherein the historical timeline support module provides an additional tool interface to allow for downloading of the as-of-this-date web page from a historical database.

9. The network browser of claim 8, wherein the additional tool interface comprises an option to download a current web page or document from the host server as default option.

10. The network browser of claim 8, wherein the additional tool interface comprises an option to download a historic original web page or document via a search engine server.

11. The network browser of claim 8, wherein the additional tool interface comprises an option to access a timeline of historical web pages or documents that is obtained using the search engine server.

12. The network browser of claim 8, wherein the additional tool interface comprises an option to download web links of prior versions of the web page or document, within a specified timeframe, that are obtained using search engine server.

13. The network browser of claim 1, wherein the network browser provides for a mouse click option on various selections associated with the web page or document, where mouse click operations on the various selections allow for the user to process certain historical search options.

14. The network browser of claim 13, wherein a certain historical search option comprises an option to download the current link web page or document from the host server.

15. The network browser of claim 13, wherein a certain historical search option comprises an option to download a historically-stored original link web page or document using the search engine server.

16. The network browser of claim 13, wherein a certain historical search option comprises an option to view a timeline of historical web pages or documents that are obtained using the search engine server.

17. The network browser of claim 13, wherein a certain historical search option comprises an option to download links of prior versions of web pages or documents, within a specified timeframe, that are obtained using the search engine server.

18. The network browser of claim 1, wherein the network browser automatically redirects the request to the search engine server, and displays the as-of-this-date web page or document in addition to notifying the user of the page not found error.

19. A method performed by a historical timeline support module associated with a browser that supports displaying of as-of-this-date web pages and documents, the method comprising:
waiting until user enters a web address that identifies content to be retrieved from a network;
sending web address information to a host server to make a request;
allowing a user to choose an as-of-this-date web page or document to satisfy the request, if an error occurs while trying to find current content to satisfy the request over the network;
redirecting web address information to the search engine server if an error occurs in processing the request;
receiving web page or document on as-of-this-date basis; and
displaying the as-of-this-date basis web page or document to satisfy the request requested by the user with some notice to the user that the provided web page or document is a historical copy.

20. The method of claim 19, wherein the browser allows the user to choose an as-of-this-date web page or document by choosing an option selected from the group consisting of: select current version, select original version, choose from a timeline view, and specify a timeframe.

21. A method performed by a search engine server that supports delivering of as-of-this-date web pages and documents over a network, the method comprising:
providing search result links in the search list to user in response to a search request by the user;
allowing the user to select historical archived content options to satisfy the search request when the current content is not available on the network, and where the historical archived content options are selected from a plurality of options;
redirecting the request to the search engine server if a search error occurs when trying to find the current content;
receiving a current web page from host server or receiving an as-of-this-date web page from a document and web page retrieval module incorporated into the search engine server depending upon the option chosen; and
displaying the received web page as either the current web page or the as-of-this-date web page, with version identification.
